(19) United States
(12) Patent Application Publication
(10) Pub. No.: US 2013/0285824 A1
(43) Pub. Date: Oct. 31, 2013

(54) FAN ROTATION SPEED TEST DEVICE

(71) Applicants: HONG FU JIN PRECISION INDUSTRY (ShenZhen) CO., LTD., (US); HON HAI PRECISION INDUSTRY CO., LTD., New Taipei (TW)

(72) Inventor: XIN-PING ZHANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/863,410

(22) Filed: Apr. 16, 2013

(30) Foreign Application Priority Data
Apr. 28, 2012 (CN) 201220187024.9

(51) Int. Cl. F04B 51/00; G01P 3/00

(52) U.S. Cl. CPC F04B 51/00; G01P 3/00
USPC 340/657; 702/145

(57) ABSTRACT

A fan rotation speed test device for testing rotation speed of a plurality of fans, includes a plurality of connectors, a display, a display control switch, and a single chip microcomputer (SCM). Each connector is connected to a corresponding fan, to output pulse signals in response to rotation of the corresponding fan. The SCM is electronically connected to the connectors, the display, and the display control switch. The SCM receives the pulse signals from the plurality of connectors, calculates and stores the rotation speed of each fan, and displays the rotation speed of one of the fans on the display at each close of the display control switch.

### BACKGROUND

1. Technical Field

The exemplary disclosure generally relates to test devices, and particularly to a fan rotation speed test device.

2. Description of Related Art

Cooling fans in a computer are usually used to dissipate the heat generated by the central processing unit (CPU) and the power supply unit (PSU). A typical test device for testing rotation speed of fans can test only one fan at a time. As a result, efficiency of the test device is very low.

Therefore, there is room for improvement within the art.

### BRIEF DESCRIPTION OF THE DRAWINGS

Many aspects of the embodiments can be better understood with reference to the drawings. The components in the drawings are not necessarily drawn to scale, the emphasis instead being placed upon clearly illustrating the principles of the disclosure.

FIG. 1 shows a circuit diagram of an exemplary embodiment of a fan rotation speed test device.

FIG. 2 shows a block diagram of a single chip microcomputer (SCM) of the fan rotation speed test device shown in FIG. 1.

### DETAILED DESCRIPTION

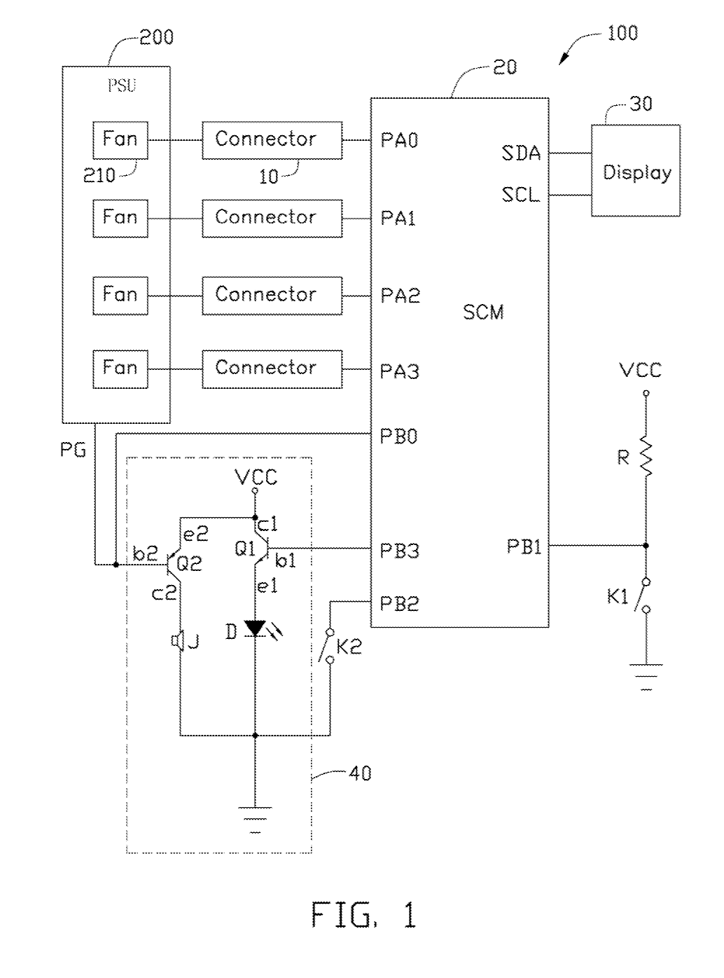

FIG. 1 shows a circuit diagram of an exemplary embodiment of a fan rotation speed test device 100. The test device 100 is used to test rotation speeds of a plurality of fans simultaneously. For example, in the exemplary embodiment, the test device 100 is used to test rotation speeds of four fans 210 (which are exemplary in number and may be greater or fewer in number) of a PSU 200. The test device 100 includes a plurality of connectors 10, a SCM 20, a display 30, an indication circuit 40, a display control switch K1, a test control switch K2, a pull-up resistor R1, and a power supply VCC.

Each connector 10 electronically connects a fan 210 with the SCM 20.

Each connector 10 transmits power to a corresponding fan 210, and transmits feedback signal of the rotation speed of the corresponding fan 210 to the SCM 20. The connector 10 detects and outputs pulse signals varying with the rotation of the fan 210 connected to the connector 10. When the fan 210 rotates one complete rotation, the connector 10 outputs a predetermined number of pulse signals.

The SCM 20 includes a data pin SDA, a clock pin SCL, a power detection pin PB0, a first control pin PB1, a second control pin PB2, a third control pin PB3, and a plurality of detection pins PA0-PA3. Each detection pin is electronically connected to one connector 10, to receive the pulse signals from the connector 10.

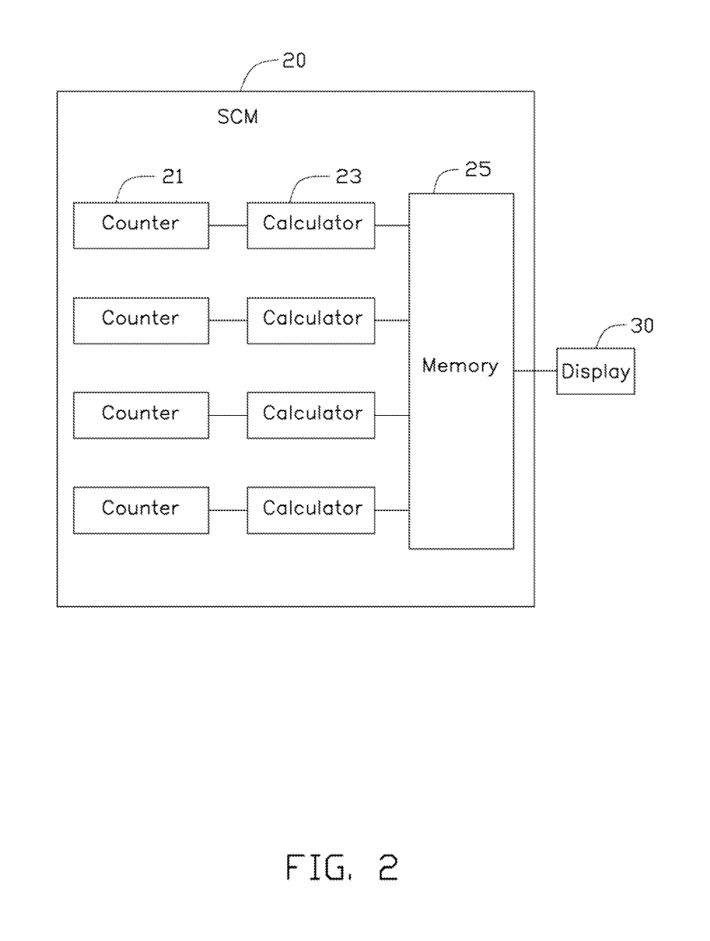

FIG. 2 shows a block diagram of the SCM 20 of the fan rotation speed test device 100 shown in FIG. 1. The SCM 20 further includes a plurality of counters 21, a plurality of calculating modules 23, and a memory 25. Each counter 21 is electronically connected to a detection pin and a calculating module 23. Each counter 21 scans the corresponding detection pin at a predetermined scan frequency, to get the number of the pulse signals in a unit time (such as one minute, for example), and outputs the number of the pulse signals to the corresponding calculating module 23. In the exemplary embodiment, the predetermined scan frequency of the counter 21 is about 3.5 KHz. Each calculating module 23 calculates a rotation speed of a corresponding fan 210 according to the number of the pulse signals, and transmits the calculated rotation speed to the memory 25. The memory 25 is electronically connected to the plurality of calculating modules 23. The memory 25 stores the rotation speed of each fan 210. In the exemplary embodiment, the memory 25 assigns a address to each fan to store the rotation speeds the fan 210, and the SCM 20 can read the rotation speed of a desired fan 210 according to a corresponding address.

In use, the SCM 20 calculates and stores the rotation speed of the fans 210 in real time. When the memory 25 is full, the data of the following rotation speeds will substitute the data of the previous rotation speeds on a first input first output principle.

The display 30 is electronically connected to the data pin SDA and the clock pin SCL of the SCM 20. The display 30 displays the rotation speeds of the fans 210. The display control switch K1 is electronically connected to the SCM 20. The SCM 20 displays the rotation speed of one of the fans 210 on the display 30 at each close of the display control switch K1. In other words, when the display control switch K1 is first closed, the SCM 20 displays the rotation speed of a first fan 210 in a predetermined sequence on the display 30; and when the display control switch K1 is opened and then closed again, the controller 30 displays the rotation speed of a second fan 210 in the predetermined sequence.

The SCM 20 determines operations of the display control switch K1 according to the voltage level of the first control pin PB1. In detail, the display control switch K1 is electronically connected between the power supply VCC and ground. The pull-up resistor R is electronically connected between the display control switch K1 and the power supply VCC. The first control pin PB1 is electronically connected to a node between the display control switch K1 and the pull-up resistor R. When the display control switch K1 is closed, the first control pin PB1 is low (e.g. logic 0); and when the display control switch K1 is opened, the first control pin is high (e.g. logic 1).

The test control switch K2 controls the operation of the SCM 20. The test control switch K2 is electronically connected to the second control pin PB2 and ground. The level of the second control pin PB2 is switched by switching the test control switch K2. In detail, when the test control switch K2 is closed, the second control pin PB2 is low, and the SCM 20 starts to detect the rotation speeds of the fans 210. When the test control switch K2 is opened, the second control pin P2 is high impedance, and the SCM 20 stops the detection.

The indication circuit 40 includes a npn type bipolar junction transistor (BJT) Q1, a pnp type BJT Q2, a light emitting diode (LED) D, and a loudspeaker J. An emitter e1 of the npn type BJT Q1 is grounded via the LED D, a base b1 of the npn type BJT Q1 is electronically connected to the third control pin PB3 of the SCM 20, and a collector cl of the npn type BJT Q1 is electronically connected to the power supply VCC. When the SCM 20 executes a rotation speed detection, the third control pin PB3 outputs a high level voltage signal (e.g. logic 1) to switch on the npn type BJT Q1, at this time, the LED D is powered on. When the SCM 20 stops the rotation speed detection, the third control pin PB3 outputs a low level voltage signal (e.g. logic 0) to switch off the npn type BJT Q1, at time, the LED is powered off.

An emitter e2 of the pnp type BJT Q2 is electronically connected to the power supply VCC; a collector c2 of the pnp type BJT Q2 is grounded via the loudspeaker J; and a base b2 of the pnp type BJT Q2 is electronically connected to the

PSU 200 to receive a power good signal PG. The power detection pin PB0 is electronically connected to a node between the base b2 and the PSU 200, to receive the power good signal PG. When the PSU 200 works, the fans 210 of the PSU 200 rotate to dissipate heat generated in the PSU 200. At this time, the power good signal PG output from the PSU 200 is high, such that the pnp type BJT Q2 is switched off, and the loudspeaker J is powered off. When the PSU 200 stops working, the fans 210 stop rotating, and the power good signal PG is low, such that the pnp type BJT Q2 is switched on, and the loudspeaker J is powered on to alarm. Meanwhile, the SCM 20 detects that the power detection pin PB0 is low, and thus stops the rotation speed detection. In other words, the SCM 20 can stop the rotation speed detection when the fans 210 stop rotating, and also can stop the rotation speed detection under the control of the test control switch K2.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A fan rotation speed test device for testing a plurality of fans, comprising:
a plurality of connectors, each connector connected to a corresponding fan, each connector outputting pulse signals in response to rotation of the corresponding fan;
a display;
a display control switch; and
a single chip microcomputer (SCM) electronically connected to the connectors, the display, and the display control switch;
wherein the SCM receives the pulse signals from the plurality of connectors, calculates a rotation speed of each fan, and displays the rotation speed of one of the fans on the display at each close of the display control switch.

2. The fan rotation speed test device of claim 1, wherein the SCM comprises a plurality of counters, a plurality of calculating modules, a memory, and a plurality of detection pins; each detection pin is electronically connected to one of the connectors, to receive the pulse signals of a fan; each counter is electronically connected to a calculating module and a detection pin, to count the pulse signals by scanning the corresponding detection pin and transmit the number of the pulse signals to the calculating module; each calculating module calculates the rotation speed of the corresponding fan according to the pulse signals transmitted from the counter, and stores the calculated rotations speed in the memory.

3. The fan rotation speed test device of claim 2, wherein a scan frequency of the counter is about 3.5 KHz.

4. The fan rotation speed test device of claim 2, wherein the memory assigns a plurality of addresses to the fans to store the rotation speeds the fans, and the SCM read the rotation speed of a desired fan according to a corresponding address of the desired fan.

5. The fan rotation speed test device of claim 1, further comprising a power supply and a pull-up resistor, wherein the display control switch is electronically connected between the power supply and ground, the pull-up resistor is electronically connected between the display control switch and the power supply; the SCM further comprises a first control pin electronically connected to a node between the display control switch and the pull-up resistor, the SCM determines operations of the display control switch according to a voltage level of the first control pin.

6. The fan rotation speed test device of claim 1, further comprising a test control switch controlling the operation of the SCM, wherein the SCM further comprise a second control pin grounded via the test control switch, the level of the second control pin is switched by controlling the switch of the test control switch.

7. The fan rotation speed test device of claim 1, further comprising a npn type BJT, a power supply, and a LED; wherein the SCM further comprises a third control pin; an emitter of the npn type BJT is grounded via the LED, a base of the npn type BJT is electronically connected to the third control pin, and a collector of the npn type BJT is electronically connected to the power supply.

8. The fan rotation speed test device of claim 7, wherein when the SCM executes a rotation speed detection, the third control pin outputs a high level voltage signal to switch on the npn type BJT, such that the LED is powered on; when the SCM stops the rotation speed detection, the third control pin outputs a low level voltage signal to switch off the npn type BJT, such that the LED is powered off.

9. The fan rotation speed test device of claim 1, further comprising a pnp type BJT, a power supply, and a loudspeaker; wherein the plurality of fans dissipate heat generated by a power supply unit (PSU), the SCM further comprises a power detection pin; an emitter of the pnp type BJT is electronically connected to the power supply, a collector of the pnp type BJT is grounded via the loudspeaker, and a base of the pnp type BJT is electronically connected to the PSU to receive a power good signal from the PSU; the power detection pin of the SCM is electronically connected to a node between the base of the pnp type BJT and the PSU, to receive the power good signal.

10. The fan rotation speed test device of claim 9, wherein when the PSU stops working, the fans stop rotating, and the power good signal is low, such that the pnp type BJT is switched on, and the loudspeaker is powered on to alarm; the SCM detects that the power detection pin is low, and thus stops detecting the rotation speed of the fans.

11. A fan rotation speed test device for testing a plurality of fans, comprising:
a plurality of connectors, each connector connected to a fan, each connector outputting pulse signals in response to rotation of the corresponding fan; and
a single chip microcomputer (SCM) electronically connected to the connectors, the SCM receives the pulse signals from the plurality of connectors, and calculates a rotation speed of each fan;
wherein the plurality of fans dissipate heat generated by a PSU, the SCM is electronically connected to the PSU to receives a power good signal that indicates work state of the PSU; the operation of the PSU is controlled by the power good signal.

12. The fan rotation speed test device of claim 11, further comprising a pnp type BJT, a power supply, and a loudspeaker; an emitter of the pnp type BJT is electronically connected to the power supply, a collector of the pnp type BJT is grounded via the loudspeaker, and a base of the pnp type BJT is electronically connected to the PSU to receive a power good signal from the PSU.

13. The fan rotation speed test device of claim 12, wherein when the PSU stops working, the fans stop rotating, and the power good signal is low, such that the pnp type BJT is switched on, and the loudspeaker is powered on to alarm; the SCM stops detecting the rotation speed of the fans.

14. The fan rotation speed test device of claim 11, wherein the SCM comprises a plurality of counters, a plurality of calculating modules, a memory, and a plurality of detection pins; each detection pin is electronically connected to one of the connectors, to receive the pulse signals; each counter is electronically connected to a calculating module and a detection pin, to count the pulse signals by scanning the corresponding detection pin and transmit the number of the pulse signals to the calculating module; each calculating module calculates the rotation speed of the corresponding fan according to the pulse signals transmitted from the counter, and stores the calculated rotations speed in the memory.

15. The fan rotation speed test device of claim 14, wherein the memory assigns a plurality of addresses to the fans to store the rotation speeds the fans, and the SCM read the rotation speed of a desired fan according to a corresponding address of the desired fan.

16. The fan rotation speed test device of claim 11, further comprising a power supply and a pull-up resistor, wherein the display control switch is electronically connected between the power supply and ground, the pull-up resistor is electronically connected between the display control switch and the power supply; the SCM further comprises a first control pin electronically connected to a node between the display control switch and the pull-up resistor, the SCM determines operations of the display control switch according to a voltage level of the first control pin.

17. The fan rotation speed test device of claim 11, further comprising a test control switch controlling the operation of the SCM, wherein the SCM further comprise a second control pin grounded via the test control switch, the level of the second control pin is switched by controlling the switch of the test control switch.

18. The fan rotation speed test device of claim 11, further comprising a npn type BJT, a power supply, and a LED; wherein the SCM further comprises a third control pin; an emitter of the npn type BJT is grounded via the LED, a base of the npn type BJT is electronically connected to the third control pin, and a collector of the npn type BJT is electronically connected to the power supply.

19. The fan rotation speed test device of claim 18, wherein when the SCM executes a rotation speed detection, the third control pin outputs a high level voltage signal to switch on the npn type BJT, such that the LED is powered on; when the SCM stops the rotation speed detection, the third control pin outputs a low level voltage signal to switch off the npn type BJT, such that the LED is powered off.
